(19) United States
(12) Patent Application Publication
(10) Pub. No.: US 2004/0165940 A1
(43) Pub. Date: Aug. 26, 2004

(54) Ball stud for suspension system

(76) Inventors: William A. Fotino, Saddle River, NJ (US); Sean McDermott, New City, NY (US); Christopher Skal, Little Falls, NJ (US); Ralph Vitolo, Middletown, NY (US)

Correspondence Address: Brian P. Hopkins, Esq., Mintz, Levin, Cohn, Ferris, Glovsky and Popeo, P.C, The Chrysler Center, 666 Third Avenue, 24th Floor, New York, NY, 10017, US

(21) Appl. No.: 10/706,446

(22) Filed: Nov. 12, 2003

Related U.S. Application Data
(60) Provisional application No. 60/449,183, filed on Feb. 21, 2003.

(51) Int. Cl. F16D 1/12

(52) U.S. Cl. 403/122

(57) ABSTRACT

The present invention is directed to ball joint assemblies, end link and motor vehicles including such items. Such ball joint assemblies may include a ball stud having a spherical surface to be received by a ball socket, a threaded portion having a specific thread diameter for being received by a corresponding fastener. The ball stud may further include a wrench flat having a deck height for receiving a tool to restrain the ball stud, correspondingly sized to the specific thread diameter.

This application claims benefit under 35 U.S.C. § 119(e) of U.S. Provisional Application No. 60/449,183, filed Feb. 21, 2003, the entire disclosure of which is herein incorporated by reference.

### FIELD OF THE INVENTION

The present invention is directed to suspension systems, and more particularly to ball joint systems and components for use in automotive suspension systems and the like.

### BACKGROUND OF THE INVENTION

Vehicle suspension systems typically include various interconnected parts to perform suspension and steering for a vehicle. For example, a wheel of a vehicle is usually mounted via a respective knuckle or spindle which rotatably and respectively support the front and/or rear wheels of the vehicle. In addition, a pair of tie rods, each of which operatively connect the steering assembly of the vehicle to a respective and unique one of the knuckles or spindles may also be provided. Further still, various other end links are used in a vehicle suspension and are connected to other structures of the suspension via a ball joint.

Typically, each ball joint includes a ball socket, which is typically and integrally formed within the outer or projecting end of a unique one of the end links, tie rods, or other suspension member, and a ball stud which resides within and which is rotatably coupled to the ball socket and which is typically attached to another suspension member (ball stud and ball socket typically referred to a “ball joint”).

From time to time, generally after a certain amount of mileage and/or age of the vehicle, ball joints must be replaced so that the vehicle performance may be maintained. In that regard, one or more ball joints are removed from the vehicle using a number of different methods applicable to a particular vehicle (e.g., ball joint removing tool, chisel, torch, and the like). Typically, ball joints cannot be removed by simply unfastening the nut at the end of the ball stud since the ball stud generally revolves in the ball socket as the affixing nut is rotated with a wrench.

When the old ball joint is removed, a new ball joint is then placed into the receiving portion of, for example, an end link, for example (or other suspension member) for housing the ball joint. The ball joint may be fastened to the end link via, for example, fasteners, clips or frictional fit (e.g., pressed into place under pressure) or otherwise. Alternatively, the ball joint assembly may be pre-assembled into a body of an end link for assembly into the vehicle.

The tip of the ball stud within the ball joint is then received by the corresponding suspension member which is affixed to the end link via the ball joint. A nut (which may include a washer) is then threaded on the end of the stud so as to “clamp” the corresponding structural member onto the ball joint. Accordingly, as one tightens the nut, the ball stud typically begins to rotate within the ball socket. To address this problem, and the problem of removing the end link from the ball stud, some manufacturers have added a wrench flat at the base of the ball stud. However, the deck height of the wrench flat, i.e., the amount of area to accept a thickness of a wrench, is inadequate to receive the appropriately sized wrench. Thus, installers must resort to other methods for tightening (or loosening) the nut from the ball stud to remove the end link (or other suspension member). Such other methods include fashioning a “home made” wrench from a piece of steel so that it can fit the wrench flat provided. Such homemade wrenches are generally insufficient for the job, and thus, they often break or are disfigured during tightening of the nut.

Thus, there exists a need to provide a ball stud for a ball joint assembly that can be used with an appropriately sized wrench so that suspension members may be adequately tightened using existing tools.

### SUMMARY OF THE INVENTION

The present invention addresses the inadequacies of the prior art and presents a new and unique ball stud for use on an automotive (including cars, trucks, farm equipment, construction equipment and the like) suspension system.

Accordingly, some embodiments of the present invention, a ball stud may include a spherical surface to be received by a ball socket, a threaded portion and a wrench flat having a novel deck height for receiving a tool to restrain the ball stud. Depending upon the size of the threaded portion, the deck height is a predetermined height.

Thus, for an 8 mm (or 5/16″) thread diameter, the deck height may be greater than about 4.50 mm, and in some embodiments, preferably between about 4.50 mm and about 6.50 mm, or greater. For a 10 mm (or ⅜″) thread diameter, the deck height may be greater than about 5.00 mm, and in some embodiments, preferably between about 5.00 mm and about 8.00 mm or greater. For a 12 mm (or 7/16″) thread diameter, the deck height may be greater than about 6.00 mm, and in some embodiments, preferably between about 6.00 mm and about 9.00 mm or greater. For a 14 mm (½″ or 9/16″) thread diameter, the deck height may be greater than about 6.00 mm, and in some embodiments, preferably between about 6.00 mm and about 10.00 mm or greater.

Other embodiments of the present invention are directed to ball joint assemblies including the ball studs according to the above embodiments and motor vehicles using such ball joint assemblies.

A groove on the ball stud shaft beneath the wrench flat may be included to accommodate the dust boot and secure it thereto with a standard round or flat profile snap retaining ring. The dust boot is preferably molded with a profile that allows it to easily mate/fit the ball stud shaft groove snugly while allowing free motion of the stud in the socket after the retaining ring is snapped into place.

Still other embodiments of the present invention include a triangular cone shaft design for maximum omni-directional motion of the ball stud in a socket assembly. For example, for a ball size of, say, approximately 20 mm diameter, the conical section is specified to approximately 9.40 millimeters in length with a draft angle of approximately 100.9±1° (complimentary angle 10.9°±1°). Depending on the spherical diameter of the ball, the conical section may be adjusted in proportion to provide the maximum omni-directional motion of the ball stud during operation. One of skill in the art will appreciate that the present invention applies to any ball size, and corresponding conical section and draft angle.

The ball stud socket, according to some embodiments, may be designed to cup around and over the equator of the ball stud sphere to provide a maximum amount of spherical surface area in contact between the ball and the socket. The socket is finger-grooved longitudinally with equal spacing to allow the ball and socket to maintain maximum surface contact. The socket may be made of a self-lubricating low friction plastic. Construction and manufacture is not limited to plastic and the socket can be made of any material with similar or superior properties including lubricated polished metal, ceramic or advanced engineering polymers.

The embodiments of the present invention will become even more clearer with reference to the attached drawing sheets and detailed description set out below.

### BRIEF DESCRIPTION OF THE DRAWINGS

FIG. 1 illustrates a perspective view of a ball joint assembly for use with an end link in an automotive suspension system according to one embodiment of the present invention.

FIG. 2 illustrates a side view of the ball joint assembly illustrated in FIG. 1.

FIG. 3 illustrates a perspective exploded view of a ball joint assembly illustrated in FIGS. 1-2.

FIG. 4 illustrates a perspective view of the ball joint assembly illustrated in FIGS. 1-3.

FIG. 5 illustrates a perspective exploded view of the ball joint assembly illustrated in FIGS. 1-4.

FIG. 6 illustrates a cross-sectional, side view of the ball joint assembly illustrated in FIGS. 1-5.

### DETAILED DESCRIPTION OF THE EMBODIMENTS

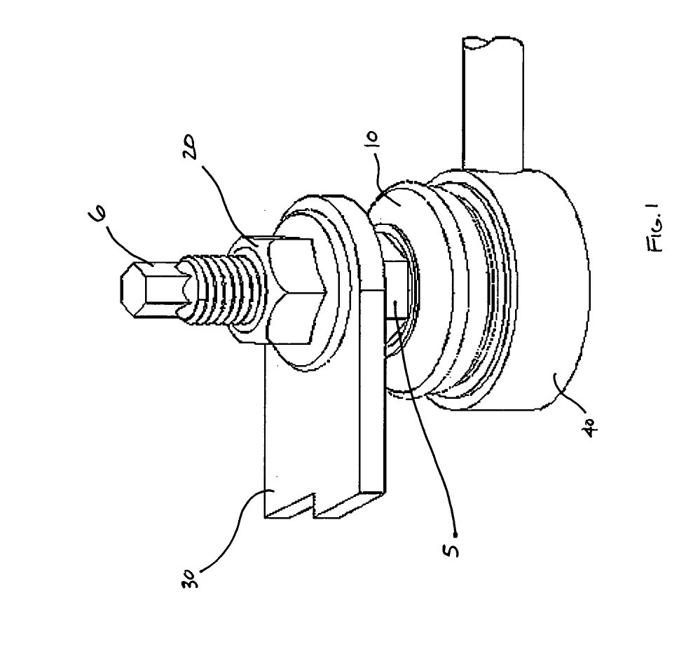

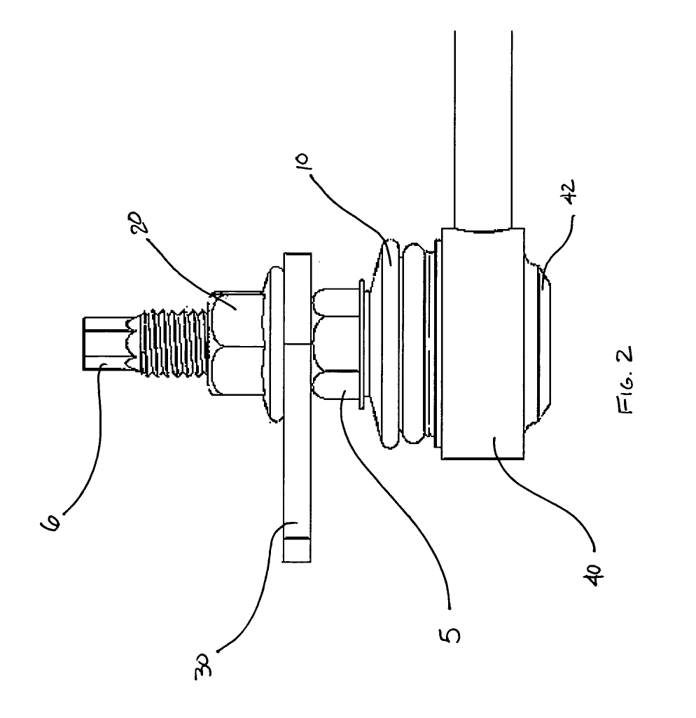

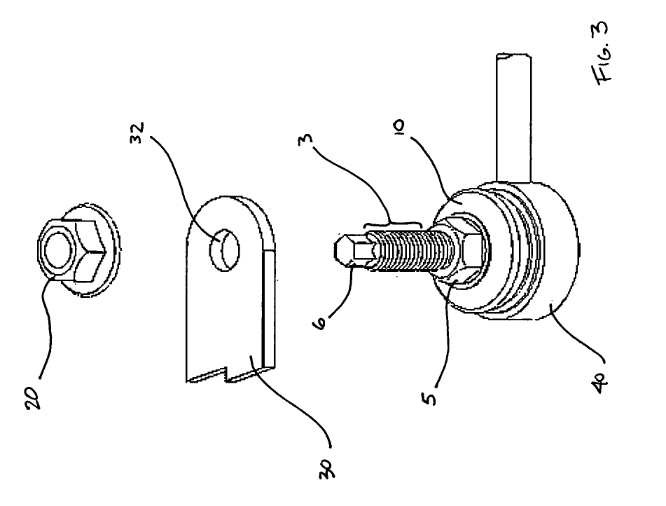

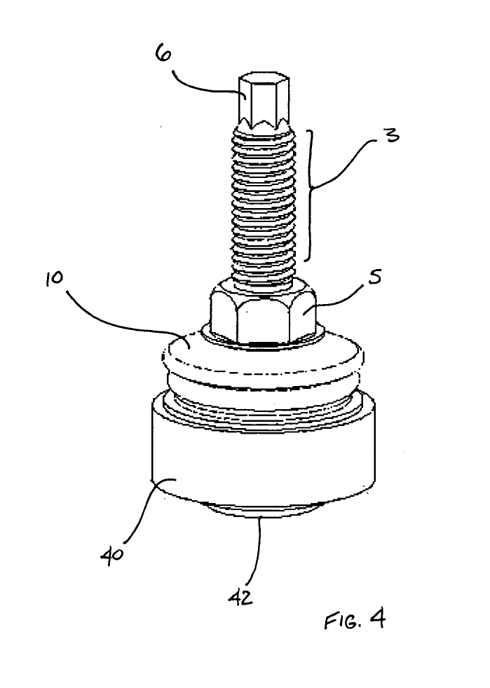

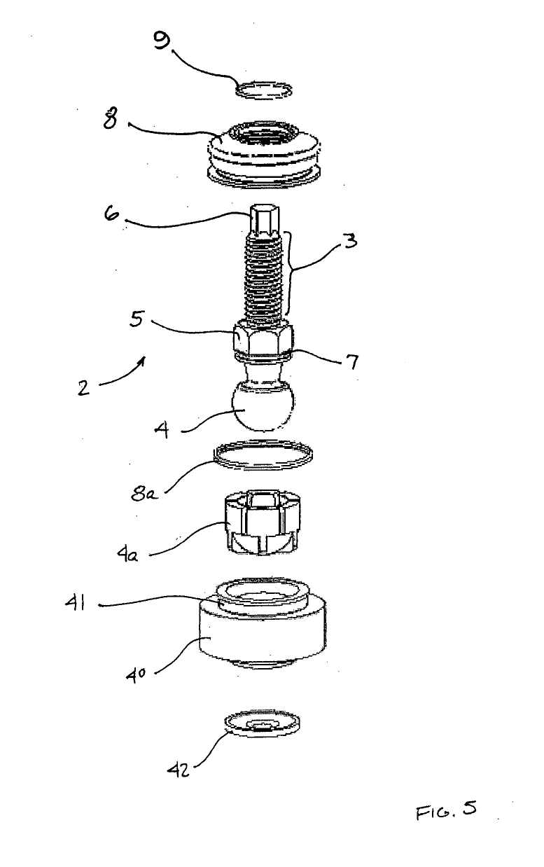

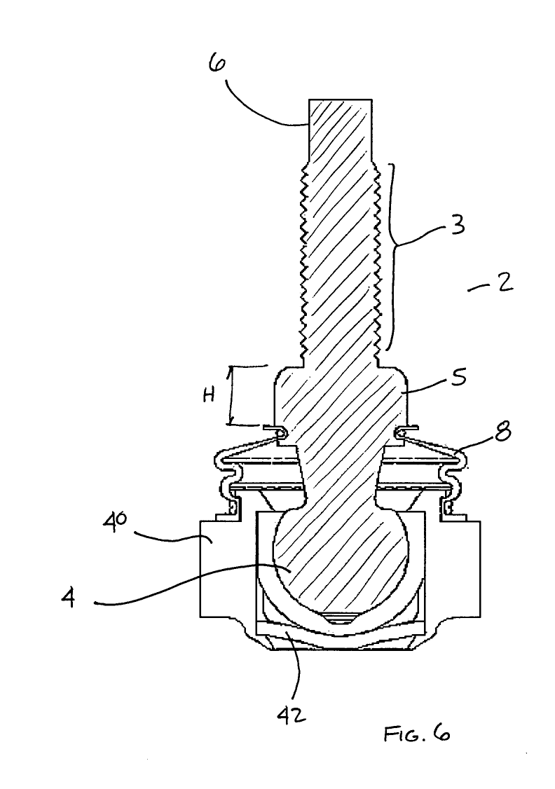

FIGS. 1-6 illustrates a ball joint assembly according to some embodiments of the present invention. Although the present invention is illustrated with use in an end link for an automotive suspension, one of skill in the art will recognize that the ball stud and/or assembly is equally applicable to any suspension application or component.

As shown in the figures, the ball joint assembly 10 according to some of the embodiments of the present invention may be housed in an end link 40, for attaching a corresponding suspension member 30 to the ball stud of the ball joint using fastener nut 20.

The ball joint assembly 10 may include a ball stud 2, having a threaded portion 3 (which may include thread diameter sizes between about 6.00 mm and about 18.00 mm, but preferably is between about 8.00 mm and 14.00 mm). At the end of the ball stud, a legacy hex may be provided (inner or outer may be provided, and may be sized proportionately to the thread diameter—i.e., the larger the thread diameter, the larger the hex).

The ball stud may also include a spherical ball surface 4 for being received in a corresponding socket 4a. In that regard, the ball socket is received, for example, by the end link body 40. Groove 7 may also be provided above the spherical surface to receive an upper portion of rubber boot 8, which is affixed thereto by upper clip 9. Rubber boot 8 protects the socket and spherical surface from the environment and keeps lubricant within the ball socket/spherical surface area. In the same regard, the end link body may include a groove 41 for accepting a lower portion of the rubber boot and corresponding lower clip 8a.

A lower washer 42 seals the bottom of the end link body/ball socket area, which may include a grease joint for pumping grease into the joint (not shown), or may be solid so as to totally seal the ball socket area.

The ball stud may include a legacy hex 6, so that an installer can utilize another wrench gripping area if necessary.

An integrated hex spanner 5 (wrench flat) may be provided for embodiments of the present invention to allow easy installation/removal of the suspension member attached to the ball stud. In that regard, the hex spanner 5 includes a novel deck height H, which is designed to accommodate the thickness of a corresponding wrench. Prior to the present invention, all manufactured tools included a thickness to large to fit prior art ball stud deck heights. Specifically, once suspension item 30 is attached to the ball stud, installers could not then use a wrench to hold the base of the ball stud near the end link (or other suspension member) since any wrench sized to fit the hex by any manufacturer was too large. Thus, applicants designed ball studs according to the embodiments of the present invention to address this problem.

Accordingly, Applicants determined the novel deck height range based upon the wrench sizes that are used to work with particular thread diameters, the results of which are listed in Table I below. Thus, for example, for an M8 (8 mm) thread diameter, a wrench size of about 12 mm to about 13 mm is used.

TABLE I

| | Approximate Min/Max Wrench Size Used |
|---|---|
| Thread Diameter | with corresponding Thread diameter |
| M8 | 12-13 mm |
| M10 | 14-17 mm |
| M12 | 17-19 mm |
| M14 | 19-23 mm |

Table II illustrates the minimum and maximum thickness of these wrench sizes from a variety of manufactures.

TABLE II

| Wrench | Wrench Width (mm) | | | | | MIN | MAX |
|---|---|---|---|---|---|---|---|
| Size | Manufacturer 1 | Manufacturer 2 | Manufacturer 3 | Manufacturer 4 | Manufacturer 5 | (mm) | (mm) |
| 12 mm | 6.00 | 6.00 | 4.50 | 5.00 | 6.00 | 4.50 | 6.00 |
| 13 mm | 6.42 | 6.00 | 4.50 | 5.00 | 6.00 | 4.50 | 6.42 |
| 14 mm | 7.00 | 7.00 | 5.00 | 5.00 | 7.50 | 5.00 | 7.50 |
| 15 mm | 7.25 | 7.00 | 5.00 | 5.50 | 7.50 | 5.00 | 7.50 |
| 16 mm | — | 7.00 | 5.00 | 5.50 | 7.50 | 5.00 | 7.50 |
| 17 mm | 7.85 | 8.00 | 6.00 | 6.00 | 8.00 | 6.00 | 8.00 |
| 18 mm | — | 8.00 | 6.00 | 6.00 | 8.00 | 6.00 | 8.00 |
| 19 mm | 8.00 | 9.00 | 6.00 | 7.00 | 8.50 | 6.00 | 9.00 |
| 20 mm | — | 9.00 | 7.00 | 7.00 | 8.50 | 7.00 | 9.00 |
| 21 mm | | 10.00 | 7.00 | 7.50 | 8.50 | 7.00 | 10.00 |
| 22 mm | — | 10.00 | 7.00 | 7.50 | 9.00 | 7.00 | 10.00 |
| 23 mm | — | 10.00 | 8.00 | 8.00 | 9.00 | 8.00 | 10.00 |

Accordingly, the deck height of the wrench flat for the following ball stud thread diameters may be as follows:

| Thread | English | Approx. | Approx. |
|---|---|---|---|
| Diameter (mm) | Equivalent | Min (mm) | Max (mm) |
| M8 | 5/16″ | 4.50 | 6.50 |
| M10 | ⅜″ | 5.00 | 8.00 |
| M12 | 7/16″ | 6.00 | 9.00 |
| M14 | ½″ or 9/16″ | 6.00 | 10.00 |

The following example is a detailed description of an embodiment of the present invention for a 12.00 mm thread diameter ball stud (for example).

### EXAMPLE

Beginning with the ball end, a close tolerance ball stud having a spherical diameter equal to approximately 20.07 mm is provided. The spherical profile of the ball preferably is within 0.10 mm or 0.004 inches, but may be greater. The spherical surface area preferably may be as large as possible for a given tolerance. The surface finish of the sphere may be ground and polished (and/or plated) to achieve a desired result.

The surface of the ball preferably is free of most imperfections such as, but not limited to: rust, pitting, scores, burrs or other marks. The ball stud also preferably includes a wrench flat of approximately 9.00 mm or less (for example), with (preferably) a limited tool mark/break off point.

The sphere may be attached to the stem via a right triangular conic shaft with a minimum (preferably) taper towards the sphere end that allows for an improved structural integrity and (preferably) maximum omni-directional motion of the ball stud when used in a socket assembly.

At the wide end of the conic shaft, directly below the integrated nut section, a groove and ring system may be included which is preferably designed to accommodate a wide range of dust boot and attachment ring configurations.

The integrated nut section, adjacent the groove and ring system, may be designed (but not limited to) to accommodate a 17 millimeter hex spanner for easy installation (for example), having a deck height of about 9.00 mm. The integrated nut allows an installer to hold the ball stud in place without spinning the sphere end in its socket. Spinning risks damage to the either the socket or the sphere.

The threaded portion of the shaft may be directly adjacent to the integrated nut and may be designed (but is not limited) with a M12×1.75 class 9.8 stud threading. However, the ball stud thread may be produced to accommodate any standard thread size.

A legacy hex head adjacent to the threaded portion of the shaft and on the end directly opposite of the spherical ball may also be designed (but is not limited to) with an appropriately hex size for the thread diameter. The legacy hex head may be used alone or in conjunction with the integrated nut for installation.

The ball stud may be manufactured from a variety of materials including SAE52100 carbon steel (or an equivalent), thru hardened to approximately Rockwell C 60 to 67 (for example). Construction and manufacture is not limited to metal and can be manufactured with advanced engineering plastics and ceramics including PEEK, Ultem, Metal-Polymer Composites.

While the present inventions have been described with a certain degree of particularity, it is obvious from the foregoing description and drawings that one skilled in the art may make one or more modifications, which are suggested, by the above descriptions of the novel embodiments.

What is claimed is:

1. A ball stud comprising a spherical surface to be received by a ball socket, a threaded portion having about an 8 mm or about a 5/16″ thread diameter for being received by a corresponding fastener, and a wrench flat having a deck height for receiving a tool to restrain the ball stud, wherein a deck height of the wrench flat is greater than about 4.50 mm.

2. The ball stud according to claim 1, wherein the deck height is less than about 10.00 mm.

3. The ball stud according to claim 1, wherein the deck height is less than about 6.50 mm.

4. The ball stud according to claim 1, further comprising an upper tool receiving portion positioned at the tip of the ball stud.

5. The ball stud according to claim 4, wherein the upper tool receiving portion comprises an outer or inner hex receiving portion.

6. A ball stud comprising a spherical surface to be received by a ball socket, a threaded portion having about an 10 mm or about a ⅜″ thread diameter for being received by a corresponding fastener, and a wrench flat having a deck height for receiving a tool to restrain the ball stud, wherein the deck height is greater than about 5.00 mm.

7. The ball stud according to claim 6, wherein the deck height is less than about 10 mm.

8. The ball stud according to claim 6, wherein the deck height is less than about 8.00 mm.

9. The ball stud according to claim 6, further comprising an upper tool receiving portion.

10. The ball stud according to claim 9, wherein the upper tool receiving portion comprises an inner or an outer hex receiving portion.

11. A ball stud comprising a spherical surface to be received by a ball socket, a threaded portion having about an 12 mm or about a 7/16″ thread diameter for being received by a corresponding fastener, and a wrench flat having a deck height for receiving a tool to restrain the ball stud, wherein the deck height is greater than about 6.00 mm.

12. The ball stud according to claim 11, wherein the deck height is less than about 12.00 mm.

13. The ball stud according to claim 11, wherein the deck height is less than about 9.00 mm.

14. The ball stud according to claim 11, further comprising an upper tool receiving portion.

15. The ball stud according to claim 14, wherein the upper tool receiving portion comprises an inner or an outer hex receiving portion.

16. A ball stud comprising a spherical surface to be received by a ball socket, a threaded portion having about a 14 mm, ½″, or 9/16″ thread diameter for being received by a corresponding fastener, and a wrench flat having a deck height for receiving a tool to restrain the ball stud, wherein the deck height is greater than about 6.00 mm.

17. The ball stud according to claim 16, wherein the deck height is less than about 12.00 mm.

18. The ball stud according to claim 16, wherein the deck height is less than about 10.00 mm.

19. The ball stud according to claim 16, further comprising an upper tool receiving portion.

20. The ball stud according to claim 19, wherein the upper tool receiving portion comprises an inner or an outer hex receiving portion.

21. A ball joint assembly comprising a ball stud having a spherical surface to be received by a ball socket, a threaded portion having about an 8 mm or about a 5/16″ thread diameter for being received by a corresponding fastener, and a wrench flat having a deck height for receiving a tool to restrain the ball stud, wherein a deck height of the wrench flat is between about 4.50 mm and 6.50 mm.

22. A ball joint assembly comprising a ball stud having a spherical surface to be received by a ball socket, a threaded portion having about an 10 mm or about a ⅜″ thread diameter for being received by a corresponding fastener, and a wrench flat having a deck height for receiving a tool to restrain the ball stud, wherein the deck height is between about 5.00 mm and about 8.00 mm.

23. A ball joint assembly comprising a ball stud having a spherical surface to be received by a ball socket, a threaded portion having about an 12 mm or about a 7/16″ thread diameter for being received by a corresponding fastener, and a wrench flat having a deck height for receiving a tool to restrain the ball stud, wherein the deck height is between about 6.00 mm and about 9.00 mm.

24. A ball joint assembly comprising a ball stud having a spherical surface to be received by a ball socket, a threaded portion having about a 14 mm, ½″, or 9/16″ thread diameter for being received by a corresponding fastener, and a wrench flat having a deck height for receiving a tool to restrain the ball stud, wherein the deck height is between about 6.00 mm and about 10.00 mm.

25. A motor vehicle having a ball joint assembly comprising a ball stud having a spherical surface to be received by a ball socket, a threaded portion having about an 10 mm or about a ⅜″ thread diameter for being received by a corresponding fastener, and a wrench flat having a deck height for receiving a tool to restrain the ball stud, wherein the deck height is between about 5.00 mm and about 8.00 mm.

26. A motor vehicle having a ball joint assembly comprising a ball stud having a spherical surface to be received by a ball socket, a threaded portion having about an 12 mm or about a 7/16″ thread diameter for being received by a corresponding fastener, and a wrench flat having a deck height for receiving a tool to restrain the ball stud, wherein the deck height is between about 6.00 mm and about 9.00 mm.

27. A motor vehicle having a ball joint assembly comprising a ball stud having a spherical surface to be received by a ball socket, a threaded portion having about a 14 mm, ½″, or 9/16″ thread diameter for being received by a corresponding fastener, and a wrench flat having a deck height for receiving a tool to restrain the ball stud, wherein the deck height is between about 6.00 mm and about 10.00 mm.
